(19) United States
(12) Patent Application Publication
(10) Pub. No.: US 2005/0117451 A1
(43) Pub. Date: Jun. 2, 2005

(54) Method and apparatus for processing seismic data

(76) Inventor: Johan O. A. Robertsson, Oslo (NO)

Correspondence Address: WESTERNGECO L.L.C., 10001 RICHMOND AVENUE, (P.O. BOX 2469, HOUSTON, TX 77252-2469, U.S.A.), HOUSTON, TX, 77042, US

(21) Appl. No.: 10/501,125

(22) PCT Filed: Jan. 9, 2003
(86) PCT No.: PCT/GB03/00050

(30) Foreign Application Priority Data
Jan. 11, 2002 (GB) 0200559.3

(51) Int. Cl. G01V 1/38

(52) U.S. Cl. 367/24

(57) ABSTRACT

A method of processing acoustic data acquired at a receiver comprises processing the acoustic data to obtain a down-going component of a parameter of the acquired acoustic data. The parameter may be, for example, the pressure acquired at the receiver or the vertical component of particle motion acquired at the receiver. The direct arrival at the receiver of acoustic energy emitted by a source may be identified in the down-going component of the parameter. Alternatively, the down-going component may be further processed to obtain a further parameter of the seismic data and the direct arrival may be identified in the further parameter. The further parameter may be, for example, the direct arrival wavefield S which may be found using S &equals; D+ZU where D and U are the up-going and down-going components of a parameter of the acquired data, and Z is a ghost operator. Applications for the invention include seismic surveying and acoustic range-finding.

The present invention relates to a method of processing data acquired at an acoustic or elastic receiver, in particular to a method of processing data that provides a more accurate identification of acoustic energy that has travelled direct from a source of acoustic energy to the receiver. The present invention may be used in, for example, seismic surveying or in an acoustic range finder.

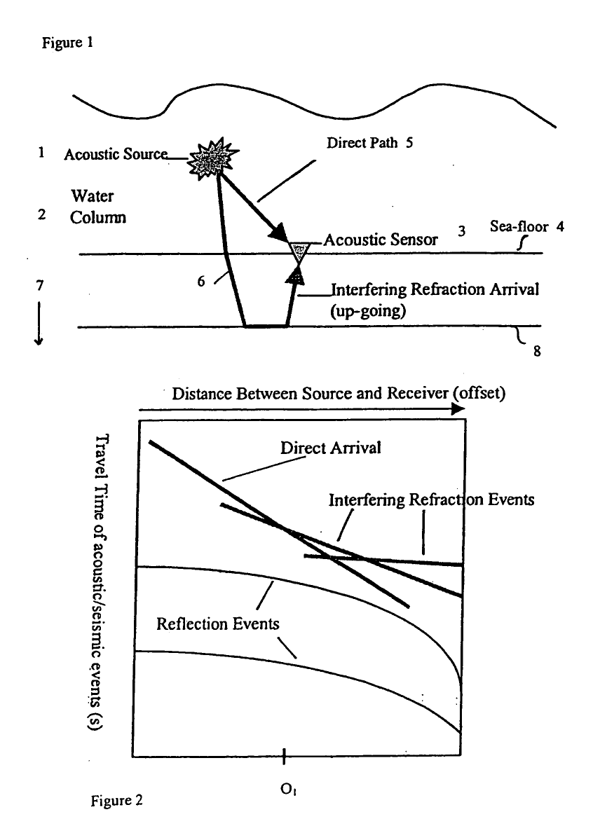

FIG. 1 is a schematic illustration of one seismic surveying arrangement. This figure shows a marine seismic arrangement in which acoustic energy is emitted by a source 1 of acoustic energy disposed in a water column 2 (such as, for example, a lake or sea). The acoustic source 1 is suspended from a towing vessel (not shown). The seismic surveying arrangement also includes a receiver 3, which is an acoustic sensor that can detect acoustic energy emitted by the acoustic source 1. In the seismic surveying arrangement of FIG. 1, the receiver 3 is disposed on the sea bed 4, but the receiver could alternatively be disposed within the water column 2 (for example suspended from another survey vessel as a “towed streamer receiver array”, or could be disposed beneath the sea-bed 4.

When the acoustic source 1 is actuated to emit acoustic energy, some of the acoustic energy that is incident on the sea-bed 4 will pass into the earth's interior and propagate downwards through the earth's interior until it is reflected by a geological feature that acts as a partial reflector of acoustic energy. The reflected acoustic energy then passes upwards through the earth's interior, and is detected by the receiver 3. It is possible to derive information about the earth's interior from acoustic energy received at the receiver 3 that has followed a path that involves such a reflection.

In order accurately to process acoustic data acquired at the sensor 3 it is necessary to know the horizontal separation between the source 1 and the sensor 3, which quantity is generally referred to as “offset”. One method of determining the offset between the source and the sensor is to make use of the seismic energy that travels directly from the source through the water column 2 to the sensor 3. This path of acoustic energy is known as the “direct path”, and is shown in FIG. 1 as 5. The event in the acoustic data acquired at the receiver 3 that arises from energy that has travelled along the direct path 5 is known as the “direct event” and, for short offsets, is the first event to be acquired at the receiver 3 following the actuation of the source.

The direct path 5 lies wholly within the water column 2, so that the travel time of acoustic energy from the source 1 to the receiver 3 along the direct path 5 depends only on properties of the water column, and these properties are well-known. It is therefore possible to obtain an accurate determination of the offset between the source 1 and the receiver 3 from the direct arrival event in the data acquired at the receiver 3. Once the direct arrival event has been identified in the data acquired at the receiver 3 it is possible to determine the travel time of acoustic energy along the direct path 5, and the offset between the source and the receiver can be determined from the travel time through knowledge of the speed of sound through water.

FIG. 1 shows only one acoustic source and one receiver. In practice, however, a typical marine seismic survey will have an array of sources and/or an array of acoustic sensors. It is therefore normally possible to determine the position of a receiver relative to the source array by a triangulation method that involves determination of the distance of the receiver from a plurality of different, known source positions. Furthermore, once the position of the receiver relative to the source array has been found the receiver coordinates may be determined of the position of the source array is known or can be determined. In the case of a source suspended at a shallow depth below the surface of the water column the source position may be determined using a GPS system.

The conventional method allows a reliable determination of the distance from the source to the sensor to be made provided that the arrival time of the direct event at the sensor 3 can be determined accurately. This is generally possible for short distances between the source and the sensor, but problems arise at longer offsets, as will be described with reference to FIG. 2.

FIG. 1 illustrates an alternative path of acoustic energy from the source 1 to the receiver 3. This path 6 is known as a “refraction path”. Acoustic energy that follows the refraction path 6 passes into the earth's interior 7, is critically refracted at an interface 8 between layers of different acoustic impedance and propagates along the interface, and then is refracted again and propagates upwards to receiver 3. A critical refraction path may also exist wholly within the water column, if the water column is stratified and contains two bodies, one overlying the other, having different densities or different acoustic velocities.

The acoustic source used in a conventional seismic survey does not usually emit acoustic energy at only a single frequency, but emits acoustic energy over a range of frequencies. The process of actuating a source to emit energy is therefore sometimes referred to as “sweeping” the source. A typical acoustic source used in a marine seismic survey will generate acoustic energy in a frequency range of from, for example, 3 Hz up to 120 Hz. Acoustic energy emitted by such a source will generate not only the direct arrival event in data acquired at the receiver, but will generate other seismic events. In particular, actuation of the acoustic source will generate refraction events caused by acoustic energy that propagates along a refraction path such as the path 6 shown in FIG. 1, and will also generate reflection events in which acoustic energy undergoes reflection at an acoustic impedance boundary deep within the earth's interior.

FIG. 2 is a schematic illustration of the travel time of acoustic energy from the source 1 to the receiver 3 in FIG. 1, as a function of the horizontal distance between the source and the receiver 3. FIG. 2 illustrates the arrival time of the direct event arising from acoustic energy that propagates along the direct path 5, the arrival time of refraction events arising from energy paths such as the refraction path 6 in FIG. 1, and the arrival time of reflection events arising from energy paths that involve reflection at an acoustic impedance boundary deep within the earth. It will be seen that at small offsets the direct event is the first event recorded at the receiver, and in this case it is possible to obtain an accurate determination of the arrival time of the direct event, since the direct arrival event should not be obscured by other events. As the offset increases, however, the difference between the arrival time at the receiver of the direct event and the arrival time at the receiver of a refraction event decreases. Eventually at some value of offset between the source and the receiver, a refraction event rather than the direct event will become the first arrival at the receiver 3—in FIG. 2, a refraction event is the first arrival at the receiver for an offset greater than the offset O₁.

Thus, at large offsets it is difficult to determine the arrival time of the direct event. It is preferable to use an automatic picking method that automatically identifies the direct event, but such an automatic picking method may be unreliable at picking the direct event if the first arrival at the sensor is a refraction event rather than the direct event. Furthermore, even if the direct event can be correctly identified, it may be difficult to determine the arrival time of the direct event accurately owing to the presence of an interfering refraction event.

A first aspect of the present invention provides a method of processing acoustic data acquired at a receiver, the method comprising the steps: of processing the acoustic data to obtain at least a down-going component of a parameter of the acquired acoustic data; and using at least the down-going component of the parameter to identify the direct arrival at the receiver of acoustic energy emitted by a source.

In a preferred embodiment the method comprises the step of identifying, in the down-going component of the parameter, the direct arrival at the receiver of acoustic energy emitted by a source.

This embodiment of the present invention makes use of the fact that acoustic energy travelling along the direct path 5 in FIG. 1 is propagating in a down-going direction at the receiver 3, while an interfering refraction event propagating along the path 6 is propagating in an up-going direction at the receiver 3. By separating a parameter of the acoustic data acquired at the receiver into an up-going component and a down-going component it is possible to separate the desired direct arrival event from the interfering refraction event. The direct arrival is present in the down-going component and the interfering refraction event is present in the up-going component—so separating the parameter of the acquired data into up-going and down-going components has the effect of separating the direct event from the interfering refraction events. The direct event may then be identified in the down-going component, and this should enable a reliable determination of the direct event even at long offsets, owing to the removal of the refraction events.

Once the direct arrival has been identified in the down-going wave field component, it is then possible to determine the travel time of acoustic energy from the source to the receiver along the direct path, and the path length of the direct path may then be obtained using knowledge of the velocity of acoustic energy in water.

The parameter of acoustic data may be, for example, the pressure acquired at the receiver, the vertical component of particle motion acquired at the receiver, or the vertical component of the pressure gradient acquired at the receiver. The term “particle motion” as used herein includes particle displacement, particle velocity and particle acceleration, and in principle also includes higher derivatives of the particle displacement.

An alternative embodiment of the invention comprises the step of processing at least the down-going component of the parameter of the acoustic data thereby to derive a further parameter of the acoustic data, and identifying in the further parameter, the direct arrival at the receiver of acoustic energy emitted by a source.

In a particularly preferred embodiment the further parameter is the direct arrival wavefield. This wavefield contains only the direct arrival event, so that the arrival time of the direct event can be reliably determined from the direct arrival wavefield for all offsets.

The present invention may be applied to processing acoustic data acquired in a seismic survey in which the source of acoustic energy is spatially separated from the receiver, to provide an indication of the separation between the source and a receiver. The invention may alternatively be applied to acoustic data acquired using an acoustic range finder in which the source is located near the receiver and where the path length of the seismic energy from the source to the receiver is indicative of the range from the range finder to an object that acts as a reflector, or partial reflector, of acoustic energy.

A second aspect of the present invention provides a method of seismic surveying comprising: actuating a source of acoustic energy to emit acoustic energy; acquiring acoustic data at a receiver; and processing the acoustic data according to a method as defined above.

A third aspect of the present invention provides an apparatus for processing acoustic data acquired at a receiver, the apparatus comprising: means for processing the acoustic data to obtain at least a down-going component of a parameter of the acoustic data; and means for identifying the direct arrival at the receiver of acoustic energy emitted by a source, using at least the down-going component of the parameter.

The apparatus may contain a programmable data processor.

A fourth aspect of the present invention provides a storage medium containing a program for the data processor of an apparatus as defined above.

A fifth aspect of the present invention provides a seismic surveying arrangement comprising: a source of acoustic energy; a receiver spatially separated from the source; and an apparatus as defined above for processing acoustic data acquired at the receiver.

A sixth aspect of the present invention provides a ranging apparatus comprising: a source of acoustic energy; a receiver located proximate to the source; and an apparatus as defined above for processing acoustic data acquired at the receiver.

Preferred embodiments of the present invention will now be described by way of illustrative example with reference to the accompanying figures in which:

FIG. 1 is a schematic illustration of a marine seismic survey;

FIG. 2 is a schematic illustration of the travel time of acoustic energy from the source to the sensor in FIG. 1 as a function of the horizontal distance between the source and the sensor,

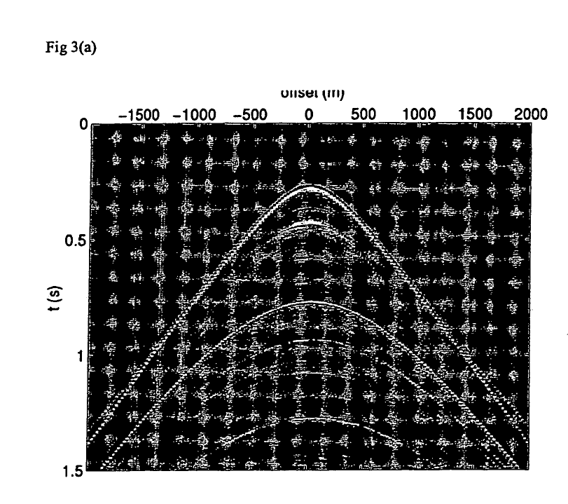

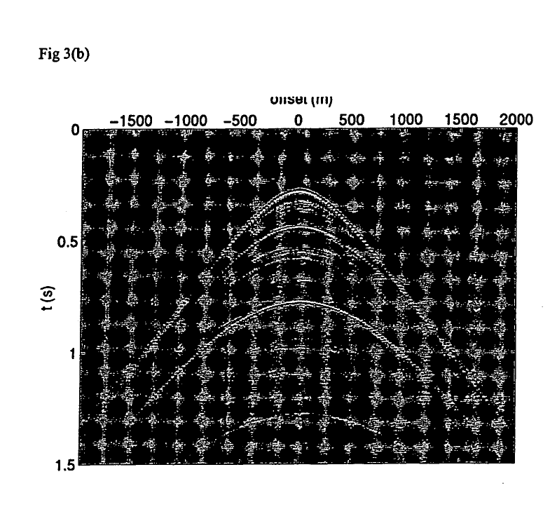

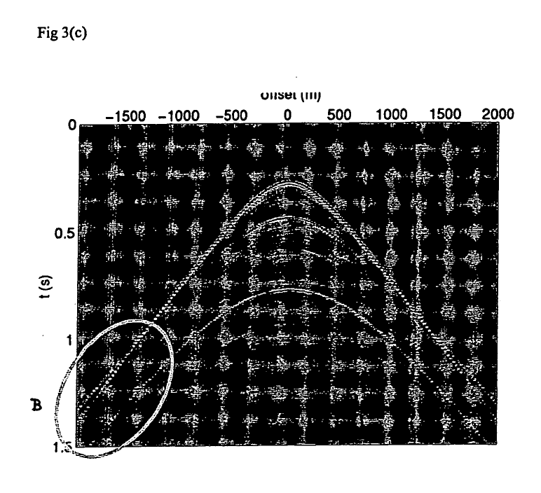

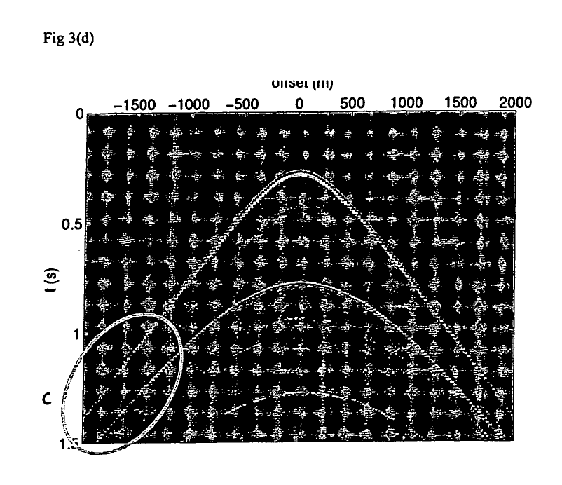

FIGS. 3(a) to 3(d) illustrate a method according to an embodiment of the present invention;

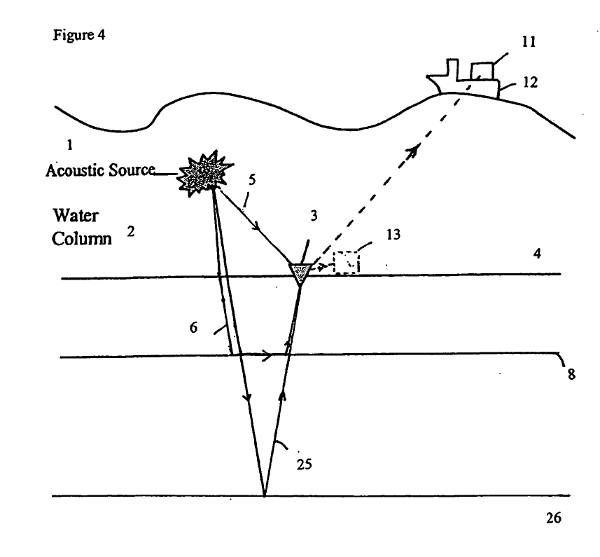

FIG. 4 is a schematic diagram of a seismic surveying arrangement of the invention;

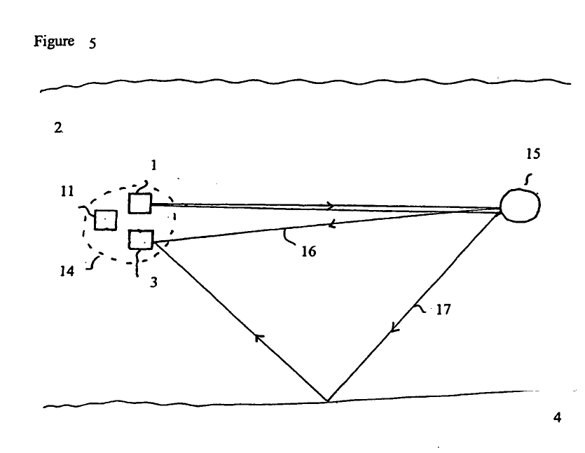

FIG. 5 is a schematic diagram of a seismic surveying arrangement of the invention; and

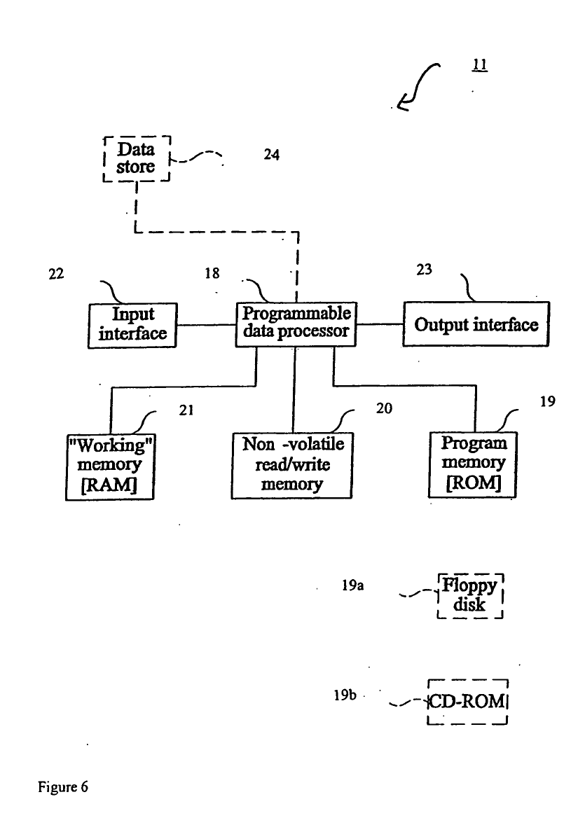

FIG. 6 is a block schematic diagram of an apparatus according to an embodiment of the present invention.

FIGS. 3(a) and 3(b) illustrate typical data acquired at a receiver in a seismic survey. These data were acquired using a multi-component receiver disposed on the sea bed. FIG. 3(a) shows the pressure recorded at the receiver (a scalar quantity), and FIG. 3(b) shows the vertical component of the particle velocity recorded at the receiver. The particle velocity is a vector quantity, and a typical multi-component receiver will record the x-, y- and z-components of the particle velocity. The x- and y-components of the particle velocity are not shown.

The horizontal axis of FIGS. 3(a) and 3(b) is the offset between the acoustic source 1 and the receiver 3. The vertical axis in the figures is the time after actuation of the seismic source. The amplitude of the acoustic energy acquired at the receiver at a particular offset/time combination is illustrated by shading, with white representing the greatest negative amplitude and black the greatest positive amplitude.

The direct arrival is indicated as 9 in FIG. 3(b). It will be seen that this is the first arrival of seismic energy for offsets in the range of approximately −1,000 m to 1,000 m.

The event labelled 10 in FIG. 3(b) is a refraction event. It will be seen that the arrival time of the refraction event 10 becomes equal to the arrival time of the direct event 9 at an offset of approximately ±1300 m. The direct event 9 and the refraction event 10 interfere with one another for offsets in the ranges of approximately −1500 to −1000 m and 1000 m to 1500 m. For offsets having a magnitude greater than 1500 m, the refraction event 10 is the first arrival at the receiver.

According to the present invention, the data acquired at the receiver is processed to obtain the down-going component of a parameter of the acoustic data. An embodiment of this invention will now be described in which the chosen parameter is the pressure acquired at the receiver. In this embodiment, the invention essentially consists of processing the pressure acquired at the receiver to obtain the down-going component of the pressure, and identifying the direct arrival in the down-going component of the pressure.

The pressure acquired at the receiver may be de-composed into its up-going component and its down-going component using suitable filters. A number of methods for separation of an acquired wave field into its up-going component and down-going component have been proposed, for example for attenuation of water-layer multiple reflections or to enhance primary reflection events. These separation methods consist essentially of applying a suitable filter to the acquired wave-field to obtain either the up-going or the down-going component.

One suitable set of filters for decomposing the acquired pressure into its up- and down-going components is the set of filters proposed by L. Amundsen and A. Reitan in “Decomposition of Multi-Component Sea-Floor Data into Up-going and Down-going P- and S- waves”, Geophysics Vol. 60, pp 563-572 (1995). This set of filters includes filters for decomposing acquired data into its p- and s-components (pressure-wave and shear-wave components) or into its up-going and down-going components. In the case of data acquired at a receiver disposed on the sea-bed, it is only necessary to decompose the recorded pressure into its up-going and down-going components in the acoustic medium (i.e. water) above the sea floor. Water does not support propagation of shear waves (s-waves), so that only pressure waves (p-waves) are present. In this case, a suitable decomposition filter for obtaining the down-going component of the pressure is:

$${P}^{D} = \frac{1}{2} ( P - \frac{ρ ω}{\sqrt{{k}_{α}^{2} - {k}_{x}^{2} - {k}_{y}^{2}}} {v}_{z} ) \qquad ( 1 )$$

where P^{D} is the desired down-going component of the pressure acquired at the receiver, P and v_{z} are the pressure and vertical component of particle velocity acquired at the receiver, p is the density of water, ω is the angular frequency of the acoustic energy, k_{d}=ω/cₐ is the magnitude of the wavenumber for p-waves in the water, cₐ is the velocity of acoustic energy in the water, and kₓ and k_{y} are horizontal wavenumbers.

The up-going component, P^{U}, of the pressure acquired at the sensor may be found using an analogous filter in which the “−” in equation (1) is replaced by “+”.

FIGS. 3(c) and 3(d) illustrate the up-going and down-going component respectively of the acquired pressure shown in FIG. 3(a) that are obtained using the filters proposed by Amundsen and Reitan. That is, the down-going component of pressure shown in FIG. 3(d) is obtained by operating on the pressure shown in FIG. 3(a) using the filter of equation (1), and the up-going component of pressure shown in FIG. 3(c) is obtained by operating on the pressure shown in FIG. 3(a) using the analogous filter for obtaining P^{U}.

It will be noted that the effect of de-composing the pressure into its up-going and down-going components is to separate the refracted arrival events from the direct arrival events. In particular, it will be noted that the refracted arrival is not present in the down-going component of the pressure shown in FIG. 3(d). The refracted arrival 10 is present only in the up-going component of the pressure, as would be expected. This may be seen by comparing the ringed areas A, B and C in FIGS. 3(b), 3(c) and 3(d) respectively.

Since the refracted arrival events are not present in the down-going component of the pressure, as shown in FIG. 3(d), picking the direct arrival event in the down-going component of the pressure provides a more reliable identification of the direct arrival event than does picking the direct arrival event in the acquired pressure shown in FIG. 3(a). Reliable picking of the direct arrival event is now possible in the entire offset range shown in FIG. 3(d). In contrast, reliable picking of the direct arrival event in the acquired pressure shown in FIG. 3(a) is possible only for offsets of a magnitude of less than 1,000 m. For greater offsets, the direct arrival event in the data of FIG. 3(a) is obscured by a refraction event.

Furthermore picking the direct arrival event in the down-going component of the pressure shown in FIG. 3(d) may be done using an automatic picking event, for all offsets shown, since the direct arrival event is the first event acquired at the receiver following actuation of the source.

It will be noted that the filter defined in equation (1) does not involve the properties of the sea-bed. It depends only on properties of the water column (the density of water and the acoustic velocity in water), and these are usually both fairly constant and well known. The present invention does therefore not require any knowledge of the properties of the sea-bed in order to improve the reliability of picking the direct arrival event.

In this embodiment, the parameter of the seismic data chosen for decomposition into up-going and down-going components was the pressure acquired at the receiver. The invention is not limited to this, and other parameters of acoustic data could be chosen. In particular, the invention could be carried out by selecting the vertical component of the particle velocity as the parameter to be decomposed into up-going and down-going components. The direct arrival may then be identified in the down-going component of the vertical particle velocity. The invention could also be carried out using, for example, the vertical pressure gradient at the receiver, the vertical particle acceleration at the receiver or the vertical particle displacement at the receiver as the parameter selected for decomposition into up-going and down-going components. In principle the invention could be carried out using the vertical component of higher derivatives of the particle displacement.

In principle two or more parameter of the acquired acoustic data can be decomposed to obtain the down-going component of each parameter. The arrival time of the direct event may then be determined from each parameter, and an average value found.

It should be noted that the x- and y- components of particle velocity acquired at the receiver are not generally suitable parameters for decomposition according to the method of the invention. These parameters are discontinuous across the sea floor and, in data acquired using a sensor disposed on the sea-bed, represent the particle motion below the sea bed.

In equation (1) above, the down-going component of the pressure is determined from only the pressure and the vertical particle velocity acquired at the receiver. No further parameters of acoustic data are required to enable decomposition of the pressure into its up-going and down-going components.

When the selected parameter of the acquired acoustic data is the pressure, the invention is not limited to the particular filter defined in equation (1) above. In principle, any method that enables the acquired pressure to be decomposed to give its down-going component can be used. For example, the down-going component of the pressure could alternatively be determined from the pressure and the vertical component of the pressure gradient, or from the pressure and the vertical component of any constituent of the particle motion (that is, from the pressure and the vertical component of the particle displacement, particle velocity or particle acceleration, or even from pressure and the vertical component of a higher derivative of the particle displacement).

Where the selected parameter of the acquired acoustic data is not the pressure but is another parameter, for example such as the vertical component of the pressure gradient or the vertical component of the particle motion, any method that enables the parameter to be decomposed to give its down-going component can again be used. For example the down-going component of the vertical component of the pressure gradient may be determined from the pressure and from the vertical component of the pressure gradient, or the down-going component of the vertical component of the particle motion may be determined from the pressure and from the vertical component of the particle motion.

The present invention may be applied to 3-C acoustic data, in which the x-, y- and z-components of particle motion (that is, particle displacement, particle velocity or particle acceleration or, in principle, higher derivatives of the particle displacement) are acquired. Where such data are available, the vertical component of particle motion may be decomposed to give its down-going component, although this requires making assumptions about the type of acoustic waves acquired by the receiver or about the number of interfering arrivals. The method put forward by W. S. Leaney in “Parametric Wave Field Decomposition and Applications”, expanded abstracts from the 60^{th} Annual International Meeting of the Society of Exploration Geophysicists, pp 1097-1100 (1990) is one suitable method for decomposing vertical particle motion acquired in 3-C data to give its down-going component.

FIGS. 3(a) to FIGS. 3(d) relate to data acquired in a common receiver gather. The invention may alternatively be implemented in the common shot domain. Implementing the invention in the common shot domain or the common receiver domain has the advantage that it may be possible to use a two-dimensional approximation of equation (1) to simplify the computation. For example, if the recordings are azimuthally symmetric the x- and y-recordings may be transformed to offset using the relationship offset²=(x−xₓ)²+(y−yₛ)², where xₛ and yₛ are the x- and y- co-ordinates of the source.

The filter given in equation (1) above is implemented in the fk domain (frequency-wave number domain). The invention may alternatively be implemented in the tau-p domain or in the fx-domain. Filters that correspond to the filter given in equation (1) for these domains are given in UK Patent Application No. 2 358 468 and PCT patent application No. WO 01/53854.

The present invention has been described above with reference to data acquired at a receiver located on the sea-bed. The invention is not limited to data acquired at a sea-bed sensor but can, in principle, be applied to any marine seismic data, land seismic data or borehole seismic data that include sufficient information to allow at least one parameter of the data to be decomposed into up- and down-going components. In particular, the invention can be applied to data acquired at a sensor disposed within the water column, such as a towed streamer array.

In the embodiment described above the acquired seismic data are decomposed to give the down-going component of a parameter of the seismic data. By analysing the down-going component as described above it is possible to identify the direct arrival easily, since the direct arrival will be the first event in the down-going wavefield, even at offsets where a refracted arrival is the first event in the acquired data. As the magnitude of the offset increases further, however, at some offset the first water-layer multiple of the critically refracted arrival will be the first event in the acquired data, arriving at the receiver before the direct arrival. This event is also a down-going event, and so will be present in the down-going component of the acquired wavefield.

In a further embodiment of the invention, therefore, the down-going component of the parameter of the acoustic data is processed to give a further parameter of the acquired acoustic data in which the direct arrival may be more easily identified or may be identified over a greater offset range.

In a particularly preferred embodiment, the further parameter is the direct arrival wavefield S. The direct arrival wavefield contains only the direct arrival, so that determining the direct arrival wavefield allows the direct arrival to be isolated from all other events in the acquired acoustic data. It is straightforward to identify the direct arrival event in the direct arrival wavefield, even at long offsets.

The direct arrival wavefield S may be found using:
S=D+ZU (2)
where, D is a down-going wavefield component, U is the corresponding up-going wavefield component and Z is a ghost-operator (see equation (34) in “Wavenumber-based filtering of marine point-source data”, by L. Amundsen, in Geophysics, Vol.58, pp1335-1348, 1993). For a flat sea-surface and a flat seafloor with a homogenous mass of water in between, the ghost operator is simply exp(2ik_{z}zᵣ), where k_{z} is the vertical wavenumber and zᵣ is the water depth. For a more complicated seafloor or a rough sea-surface other ghost operators can alternatively be derived and used.

In this embodiment, therefore, the acquired acoustic data is processed by calculating the up-going and down-going components of a parameter of the acquired data, such as, for example, the up-going and down-going components of the acquired pressure, particle motion or vertical pressure gradient. The appropriate ghost operator is derived from knowledge of the seafloor at the survey location and of the state of the sea-surface during the survey. The direct arrival wavefield S is then determined using equation (2).

When the direct arrival wavefield S is determined for data acquired at a single receiver, it should contain only a single event—which is the arrival of the direct wave at the receiver. Determining the direct arrival wavefield S isolates the direct event from all other events. It is therefore straightforward in principle to determine the arrival time of the direct event from the direct arrival wavefield S.

In the embodiments described above, the invention has been applied on the receiver side. The invention can in principle be applied on the source side, using the reciprocity theorem (which states that the data are unaffected if the sources and receivers are inter-changed). The invention may be applied on the source side if multi-components sources are used or if sources located at different depths but at the same shot point are used.

FIG. 4 is a schematic illustration of a seismic surveying arrangement according to an embodiment of the invention. As the conventional seismic surveying arrangement shown in FIG. 1, this comprises an acoustic source 1 disposed within the water column 2, and an acoustic receiver 3. The receiver 3 is shown located on the sea-floor 4 in FIG. 4, but the invention is not limited to this and the receiver could alternatively be located in the water column.

Three possible paths of acoustic energy from the source to the receiver are shown in FIG. 4. These are the direct path 5, a refracted path 6, and a primary reflection path 25 that involves reflection at an acoustic impedance boundary 26 deep within the earth. (The primary reflection path 25 will involve refraction at the sea floor and at the acoustic impedance boundary 8, but this refraction has been emitted from FIG. 4 for clarity.)

The seismic surveying arrangement of the invention further includes a processing apparatus 11 for processing acoustic data acquired at the receiver 3 as a consequence of actuation of the acoustic source 1. This is shown, for illustrative purposes, as being located on a survey vessel 12, but the processing apparatus 11 may be located elsewhere. Data may be transmitted from the receiver 3 to the processing apparatus 11 directly, as indicated by the path 14 in broken lines. Alternatively, data may be stored in a buffer memory 13. Data stored in the buffer memory 13 may be retrieved and transmitted to the processing apparatus 11 at the conclusion of the survey, or it may be transmitted to the processing apparatus at intervals throughout the course of the seismic survey.

The processing apparatus 11 is adapted to process the data acquired at the receiver 3 so as to obtain the down-going component of at least one parameter of the data. For example, the processing apparatus 11 may decompose the pressure or the vertical particle velocity acquired at the receiver 3 to obtain the down-going component of pressure or the down-going component of particle velocity. This may be done according to any of the methods described above.

The processing apparatus 11 is further adapted to identify the direct arrival event in the data relating to the down-going component of the parameter. Thus, if the processing apparatus has obtained the down-going component of the pressure acquired at the receiver 3, it would then identify the direct arrival event in the down-going component of the pressure. As explained above, this enables accurate identification of the direct arrival event at greater offsets and if the identification is made on the basis of the total pressure acquired at the receiver. The direct arrival event may be identified using an automatic picking technique, or the down-going component of the selected parameter may be displayed to allow manual picking of the direct arrival event.

The processing apparatus 11 may be adapted to carry out further processing steps. For example, once the arrival time of the direct arrival event has been determined, it may determine the offset between the source and the receiver, using knowledge about the velocity of propagation of acoustic energy through the water column 2. The processing apparatus 11 may further be adapted to process other events in the data acquired at the receiver 3 taking into account the determined offset between the source 1 and the receiver 3. For example, the processing apparatus 11 may take the offset between the source and the receiver 3 that is determined from the direct arrival event into account when processing events in the seismic data relating from a primary reflection path such as the path 25.

In an alternative embodiment, the processing apparatus 11 is adapted to process the data acquired at the receiver 3 so as to obtain the down-going component and down-going component of at least one parameter of the data, and to calculate the parameter S using equation (2) above. For example, the processing apparatus 11 may decompose the pressure or the vertical particle velocity acquired at the receiver 3 to obtain the up-going and down-going components of pressure or the up-going and down-going components of particle velocity. The parameter S can then be determined from the up-going and down-going components of the pressure or the particle velocity, using a suitable ghost operator, and the direct event may then be identified in the parameter S.

FIG. 5 illustrates an acoustic range finding apparatus according to the present invention.

An acoustic range finder consists essentially of a source of acoustic energy 1 and an acoustic sensor 3. The acoustic source 1 and the acoustic sensor 3 are disposed close to one another. The acoustic source 1 and the acoustic sensor may be disposed adjacent to one another, although this is not essential provided that the separation between the acoustic source 1 and the acoustic sensor is small compared to the intended operating range of the range finder. In FIG. 5 the acoustic source 1 and the acoustic sensor 3 are shown as being mounted in a common housing 14, for illustrative purposes.

In operation, the acoustic source 1 emits a pulse of acoustic energy. This is reflected by an object in the water column 2, and the reflected acoustic energy is detected by the sensor 3. The range from the acoustic range finder to the object 15 may be determined from the travel time of seismic energy from the seismic source 1, along the direct path 16 via the object 15 to the acoustic sensor 3. The travel time is indicative of the distance to the object 15, since the distance to the object 15 is approximately half the path length of seismic energy from the source 1 to the receiver 3 via the object 15. In order to determine the range to the object 15 it is therefore necessary to determine the travel time of acoustic energy from the source 1 to the receiver 15 and back to the receiver 3 along the direct path 16, and this requires accurate detection of the time at which reflected seismic energy is acquired by the sensor 3.

Many paths of seismic energy exist from the source 1 to the sensor 3 in addition to the direct path 16 shown in FIG. 5. For example, reference 17 denotes a path in which seismic energy is reflected downwards by the object 15, is reflected upwards by the sea-bed 4 and is incident on the sensor 3. The travel time of seismic energy from the source to the sensor along the path 17 will not be the same as the travel time along the direct path 16. If seismic energy that has travelled along the path 17 that involves reflection at the sea-bed were mistakenly identified as seismic energy that had travelled along the direct path 16, this would lead to an error in determination of the distance of the object 15. It is therefore important to ensure that that acoustic energy that has travelled from the source 1 to the receiver 3 along the direct path 16 can be reliably identified.

The present invention may be applied to an acoustic range finder to improve the reliability of identifying seismic energy that has travelled along the direct path 16 shown in FIG. 5. It will be noted that seismic energy that travels along the direct path 16 is propagating downwardly at the sensor 3, whereas acoustic energy that propagates along the path 17 is propagating upwardly at the sensor 3. It is therefore possible to improve the reliability of the detection of seismic energy that has travelled along the direct path 16 by decomposing at least one parameter of the acoustic data acquired at the sensor 3 so as to obtain the down-going component of that parameter. Seismic energy that has travelled along the direct path 16 may then be identified in the down-going component.. This should provide more reliable identification of the direct seismic energy, since seismic energy that travelled along the path 17 will not be present in the down-going component of the seismic data.

An acoustic range finder of the present invention therefore incorporates a processing apparatus 11 that is adapted to determine the down-going component of at least one parameter of the acoustic data acquired at the receiver. In FIG. 5 the processing apparatus is shown as being disposed within the housing 14, but the processing apparatus 11 may in principle be disposed elsewhere. The processing apparatus 11 may obtain the down-going component of the selected parameter of the acoustic data acquired at the sensor 3 in any of the ways described above. The processing apparatus 11 is further adapted to identify the arrival of acoustic energy along the direct path 16 in the down-going component of the selected parameter of the seismic data.

The processing apparatus may alternatively identify the arrival of acoustic energy along the direct path 16 by determining the direct event in the parameter S, as described above.

The processing apparatus 11 may further be adapted to determine the distance to the object 15. Once the travel time of seismic energy from the source 1 to the receiver 3 along the direct path 16 has been identified, the total path length can be determined from knowledge of the velocity of propagation of acoustic energy in the water column 2. The range to the object 15 is half the path length of the path 16 (assuming that the lateral separation between the source 1 and the receiver 3 is small compared to the range to the object 15).

The invention has been described primarily with reference to acoustic data in the context of a seismic surveying arrangement. The invention is not limited, however, to use in seismic surveying, and may be applied to any acoustic ranging or acoustic positioning system or technique.

FIG. 6 is a schematic block diagram of a data processing apparatus 11 according to the present invention. The apparatus is able to process acoustic data so as to obtain the down-going component of at least one parameter of the seismic data.

The apparatus 11 comprises a programmable data processor 18 with a program memory 19, for instance in the form of a read only memory (ROM), storing a program for controlling the data processor 18 to process acoustic data by a method of the invention. The apparatus further comprises non-volatile read/write memory 20 for storing, for example, any data which must be retained in the absence of a power supply. A “working”, or “scratch pad” memory for the data processor is provided by a random access memory RAM 21. An input device 22 is provided, for instance for receiving user commands and data. An output device 23 is provided, for instance, for displaying information relating to the progress and result of the processing. The output device may be, for example, a printer, a visual display unit, or an output memory.

Acoustic data for processing may be supplied via the input device 22 or may optionally be provided by a machine-readable store 24.

The program for operating the system and for performing the method described hereinbefore is stored in the program memory 19, which may be embodied as a semiconductor memory, for instance of the well known ROM type. However, the program may well be stored in any other suitable storage medium, such as a magnetic data carrier 19a (such as a “floppy disc”) or a CD-ROM 19b.

1. A method of processing acoustic data acquired at a receiver, the method comprising the steps: of processing the acoustic data to obtain at least a down-going component of a parameter of the acquired acoustic data; and using at least the down-going component of the parameter to identify the direct arrival at the receiver of acoustic energy emitted by a source.

2. A method as claimed in claim 1 and comprising the step of identifying, in the down-going component of the parameter, the direct arrival at the receiver of acoustic energy emitted by a source.

3. A method as claimed in claim 1, wherein the parameter of acoustic data is pressure.

4. A method as claimed in claim 3 and comprising determining the down-going component of the pressure from the pressure acquired at the receiver and from either the vertical component of the particle motion acquired at the receiver or the vertical component of the pressure gradient acquired at the receiver.

5. A method as claimed in claim 1, wherein the parameter of acoustic data is the vertical component of particle motion acquired at the receiver or is the vertical component of the pressure gradient acquired at the receiver.

6. A method as claimed in claim 5 and comprising determining the down-going component of the vertical component of particle motion from the pressure acquired at the receiver and from either the vertical component of the particle motion acquired at the receiver or the vertical component of the pressure gradient acquired at the receiver.

7. A method as claimed in claim 4, wherein the vertical component of particle motion is the vertical component of particle acceleration.

8. A method as claimed in claim 4, wherein the vertical component of particle motion is the vertical component of particle velocity.

9. A method as claimed in claim 3, wherein the step of determining the down-going component of the pressure comprises determining:
$${P}^{D} = \frac{1}{2} ( P - \frac{ρ a}{\sqrt{{k}_{a}^{2} - {k}_{x}^{2} - {k}_{y}^{2}}} {v}_{z} ) \qquad ( 1 )$$
where P is the pressure acquired at the receiver, v_{c} is the vertical component of particle velocity acquired at the receiver, p is the density of water, a is the angular frequency of the acoustic energy, kₐ=a/cₐ is the magnitude of the wavenumber for acoustic energy in the water, cₐ is the velocity of acoustic energy in water, and kₓ and k_{y} are horizontal wavenumbers.

10. A method as claimed in claim 1 and comprising processing at least the down-going component of the parameter of the acoustic data thereby to derive a further parameter of the acoustic data, and identifying in the further parameter, the direct arrival at the receiver of acoustic energy emitted by a source.

11. A method as claimed in claim 10 wherein the further parameter is the direct arrival wavefield.

12. A method as claimed in claim 1, further comprising the step of determining the path length of acoustic energy from the source to the receiver from the direct arrival of acoustic energy at the receiver.

13. A method as claimed in claim 12 wherein the source is spatially separated from the receiver, and wherein the path length of seismic energy from the source to the receiver is indicative of the separation between the source and the receiver.

14. A method as claimed in claim 12 wherein the source is proximate to the receiver, and wherein the path length of seismic energy from the source to the receiver is indicative of the range from the source and receiver to a reflector of acoustic energy.

15. A method of seismic surveying comprising: actuating a source of acoustic energy to emit acoustic energy; acquiring acoustic data at a receiver; and processing the acoustic data according to a method as defined in any of claims 1 to 3, 5, 10, and 12.

16. An apparatus for processing acoustic data acquired at a receiver, the apparatus comprising: means for processing the acoustic data to obtain at least a down-going component of a parameter of the acoustic data; and means for identifying the direct arrival at the receiver of acoustic energy emitted by a source, using at least the down-going component of the parameter.

17. An apparatus as claimed in claim 16 and wherein the means for identifying the direct arrival are adapted to identify the direct arrival in the down-going component of the parameter.

18. An apparatus as claimed in claim 16 and comprising means for processing at least the down-going component of the parameter of the acoustic data thereby to derive a further parameter of the acoustic data; and d, and wherein the means for identifying the direct arrival are adapted to identify the direct arrival in the further parameter.

19. An apparatus as claimed in claim 16, further comprising means for determining the path length of acoustic energy from the source to the receiver from the direct arrival of acoustic energy at the receiver.

20. An apparatus as claimed in claim 16, comprising a programmable data processor.

21. A storage medium containing a program for the data processor of an apparatus as defined in claim 20.

22. A seismic surveying apparatus comprising: a source of acoustic energy; a receiver spatially separated from the source; and an apparatus as defined in any of claims 16 to 20 for processing acoustic data acquired at the receiver.

23. A ranging apparatus comprising: a source of acoustic energy; a receiver located proximate to the source; and an apparatus as defined in any of claims 16 to 20 for processing acoustic data acquired at the receiver.
